(19) United States
(12) Patent Application Publication
(10) Pub. No.: US 2015/0113975 A1
(43) Pub. Date: Apr. 30, 2015

(54) THERMAL ACTUATOR

(71) Applicant: Woodward, Inc., Fort Collins, CO (US)

(72) Inventors: Michael B. Riley, Fort Collins, CO (US); James Ambrosek, Fort Collins, CO (US); Kumaresh Gettamaneni, Wellington, CO (US); Nolan Polley, Longmont, CO (US); R.J. Way, Fort Collins, CO (US)

(21) Appl. No.: 14/068,230

(22) Filed: Oct. 31, 2013

(51) Int. Cl. F03G 7/06

(52) U.S. Cl. CPC F03G 7/06
USPC 60/529; 60/527

(57) ABSTRACT

Disclosed is a thermal actuator that utilizes the dimensional change of a phase change media hermetically sealed within a shell. This thermal actuator may be utilized in a variety of environments where electric thermostatic actuators are impossible or impractical.

### CROSS REFERENCE TO RELATED APPLICATION

This application is based upon and claims the benefit of United States application number 61/712,939, entitled “High-Temperature Thermal Actuator Utilizing Phase Change Material”, filed Oct. 12, 2012, the entire disclosure of which is hereby specifically incorporated by reference for all that it discloses and teaches.

### BACKGROUND OF THE INVENTION

In numerous applications control devices are required to switch between various states at given temperatures, or temperature ranges. These devices may be active or passive. An example of a passive low temperature device is an automotive thermostat, which typically operates below 130° C. These thermostats may utilize wax pellets whose composition is chosen for the temperature range to be served. Other passive devices may include bimetallic strips, whose temperature-affected shape change is utilized to facilitate a physical actuation.

These designs are typically only viable at low temperature, and currently, there are no passive thermostats capable of applying large mechanical forces with reliable operation at higher temperatures. Bimetallic thermostats are most often used with active electronic control where the bimetallic elements close contacts for an electric circuit. There is a need for a self-contained, mechanical thermostatic control device that is operable at higher temperatures and is capable of providing sufficient actuation force.

One embodiment that has been contemplated is disclosed in U.S. Nonprovisional patent application Ser. No. 13/801,734, entitled “High-Temperature Thermal Actuator Utilizing Phase Change Material” by Michael B. Riley et al., filed Mar. 13, 2013, the entire content of which is hereby specifically incorporated herein by reference for all it discloses and teaches.

### SUMMARY OF THE INVENTION

An embodiment of the present invention may therefore comprise: a sealed volumetric confine comprising: an upper endplate orthogonal to an axial orientation; a lower endplate orthogonal to an axial orientation, approximately parallel to, and offset by, a distance from the upper endplate; at least one flexible support wall that is disposed in a circumferential orientation to engage the upper endplate and the lower endplate, thereby forming the sealed confine; and, a phase change media disposed within the confine, the phase change media that responds to a temperature change to exert dimensional force in the axial orientation upon a change of state, thereby changing the distance between the upper endplate and the lower endplate.

An embodiment of the present invention may also comprise: a method of affecting mechanical displacement with a thermal actuator comprising: providing a sealed volumetric confine comprising: an upper endplate orthogonal to an axial orientation; a lower endplate orthogonal to an axial orientation, approximately parallel to, and offset by, a distance from the upper endplate; at least one flexible support wall that is disposed in a circumferential orientation to engage the upper endplate and the lower endplate, thereby forming the sealed confine; providing a phase change media within the volume of the confine; heating or cooling the phase change media beyond a phase transition point thereby affecting a change in state of the phase change media by changing the temperature of the phase change media disposed within the confine thereby affecting a change in volume of the confine; and, creating a change in displacement between the upper endplate the lower endplate with the force exerted by the phase change media upon the change of state.

### BRIEF DESCRIPTION OF THE DRAWINGS

In the drawings,

FIG. 1 illustrates an embodiment of a container shape for a thermal actuator assembly.

FIG. 2 illustrates another embodiment of a container shape for a thermal actuator assembly.

FIG. 3 illustrates another embodiment of a container shape with corrugated surfaces for a thermal expansion module for a thermal actuator assembly.

FIG. 4 illustrates a cross-section of the geometry shown in FIG. 3.

FIG. 5 illustrates an alternative embodiment to the cross-section the geometry shown in FIG. 3.

FIGS. 6A and 6B illustrate an embodiment of an external bellows geometry for the container shape for a thermal actuator assembly.

FIGS. 7A and 7B illustrate an embodiment of an internal bellows geometry for the container shape for a thermal actuator assembly.

FIGS. 8A and 8B illustrate an embodiment of a multiple bellows geometry for the container shape for a thermal actuator assembly.

FIGS. 9A and 9B illustrate an embodiment of an external bellows geometry producing both a decreased displacement and an increased displacement for a thermal actuator assembly.

FIG. 10 illustrates another embodiment of an external bellows geometry producing both a decreased displacement and an increased displacement for a thermal actuator assembly.

### DETAILED DESCRIPTION OF THE INVENTION

While this invention is susceptible to embodiment in many different forms, it is shown in the drawings, and will be described herein in detail, specific embodiments thereof with the understanding that the present disclosure is to be considered as an exemplification of the principles of the invention and is not to be limited to the specific embodiments described.

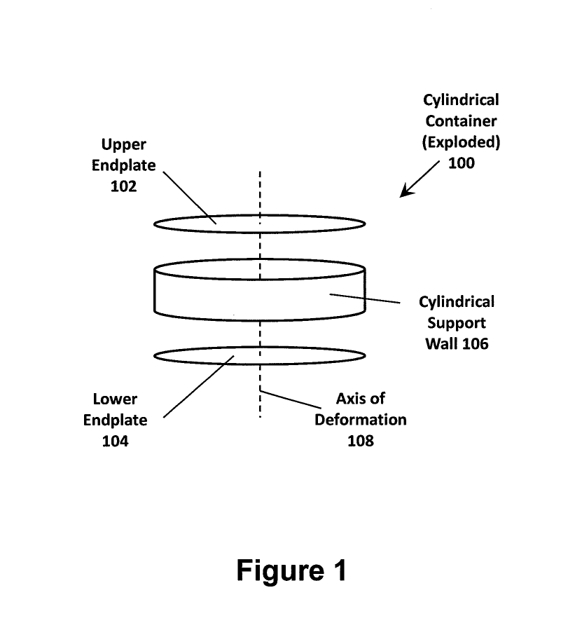

FIG. 1 is an embodiment of a simple cylindrical container assembly 100 for a high temperature thermal actuator of the type that was described in U.S. application number Ser. No. 13/801,734, entitled “High-Temperature Thermal Actuator Utilizing Phase Change Material”, filed Mar. 13, 2013, the entire disclosure of which is hereby specifically incorporated by reference for all that it discloses and teaches. The exemplary embodiment of container 100 depicted in FIG. 1 provides an enclosure that deforms along axis of deformation 108 in response to the dimensional change of a phase change media (not shown), hermetically sealed within a cylindrical support wall 106 encased with disks (upper endplate 102 and lower endplate 104) in this embodiment. The upper endplates 102 and 104 may be welded, brazed, glued, press fit, or any other manner of joining that may facilitate a hermetic seal.

The functional temperature range for the embodied design may be within 200° C. to 1000° C. range, with volume and displacement change and be tunable to allow accurate temperature actuation by an appropriate selection of phase change medium. The system, as disclosed, is capable of providing large actuation forces with a long life cycle at relatively low cost.

Specific usage constraints are easily addressed with the aforementioned system. In various applications, such as hot or cold climates/environments, the activation (phase change) temperatures may be shifted to an optimal point by varying the formulation, concentration and geometry of the phase change media. This provides a great advantage over conventional low-temperature thermostatic valves that are driven by bimetallic elements, low temperature paraffin filled pistons or thermocouples.

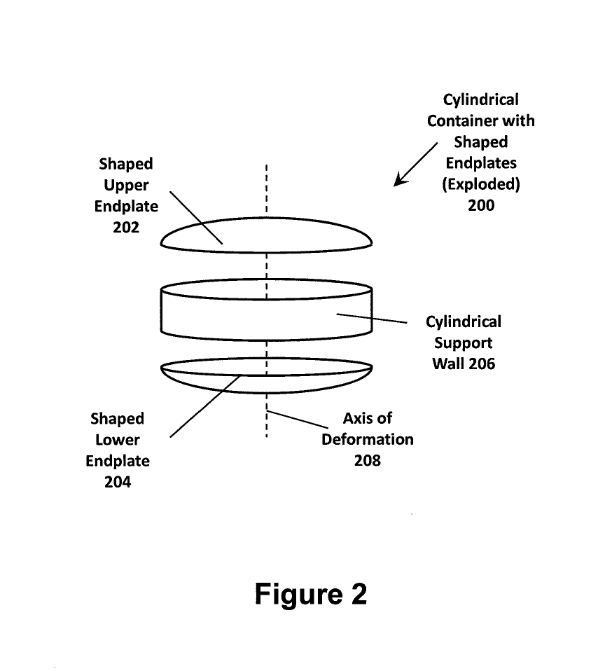

FIG. 2 is another exemplary embodiment of a cylindrical container 200 for a high-temperature thermal actuator. FIG. 2 exemplifies a container 200 that can be filled with a phase change media (not shown), disposed within the sealed confines, and acting to exert dimensional force in at least one direction in response to a temperature change that causes the media to undergo a change in phase. As with other disclosed embodiments, this change in phase may be solid-to-liquid, liquid-to-solid, liquid-to-gas, solid-to-gas, or a change in the crystalline arrangement within the material that causes a volumetric or dimensional change in the material in response to a change in temperature that is beyond simple thermal expansion. The module 200 in this example consists of two shaped endplates (e.g., metal disks) 202 and 204 hermetically joined to a configurable cylindrical section 206 in between to form a “puck”. The upper and lower endplates 202 and 204 may have non-planar shapes that affect the volume of the phase change material enclosed and/or are shaped to minimize stresses in the caps for the intended displacement, for example by avoiding tight radius edges between the endplates 202 and 204 and the cylindrical section 206. The caps may be welded, brazed, glued, press fit, or any other manner of joining that may facilitate a hermetic seal of the cylindrical phase change media chamber 200.

In this embodiment, for a particular diameter, the height of the cylindrical wall 206 defines the enclosed volume of phase change material. Different applications with different thermal requirements, and therefore, different volume expansions lead to customization of the tube height. This customization affects the dimension of only one part for each diameter, thus providing a simple manner in which to execute variations in expansion characteristics.

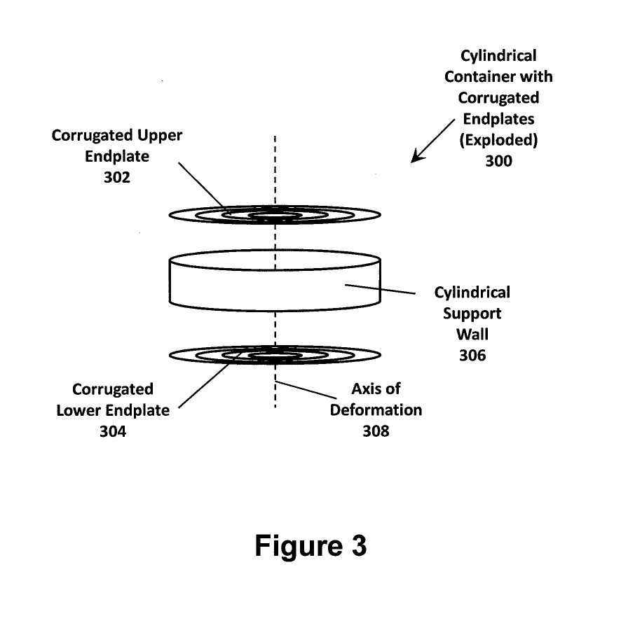

FIG. 3 is another exemplary embodiment of a cylindrical container 300 for a high-temperature thermal actuator. FIG. 3 exemplifies a container 300 that can be filled with a phase change media (not shown), disposed within the sealed confines, and acting to exert dimensional force in at least one direction in response to a temperature change that causes the media to undergo a change in phase. This change in phase may be solid-to-liquid, liquid-to-solid, liquid-to-gas, solid-to-gas or a change in the crystalline arrangement within the material that causes a volumetric or dimensional change in the material in response to a change in temperature that is beyond thermal expansion. The module 300 in this example consists of one or more essentially corrugated endplates (metal disks) 302 and 304 and a cylindrical support wall 306. The corrugated metal disks are opposing sides of an envelope, the volume of which is defined by the radius of the disk and the spacing, which is determined in this example by the cylindrical support wall 306. This may be welded, brazed, glued, press fit, or any other manner of joining that may facilitate a hermetic seal of the phase change media chamber 300. The corrugations enable distribution of stresses across multiple bends, increasing overall displacement of the opposing centers of the endplates 302 and 304, while remaining at stress levels below the point of permanent deformation.

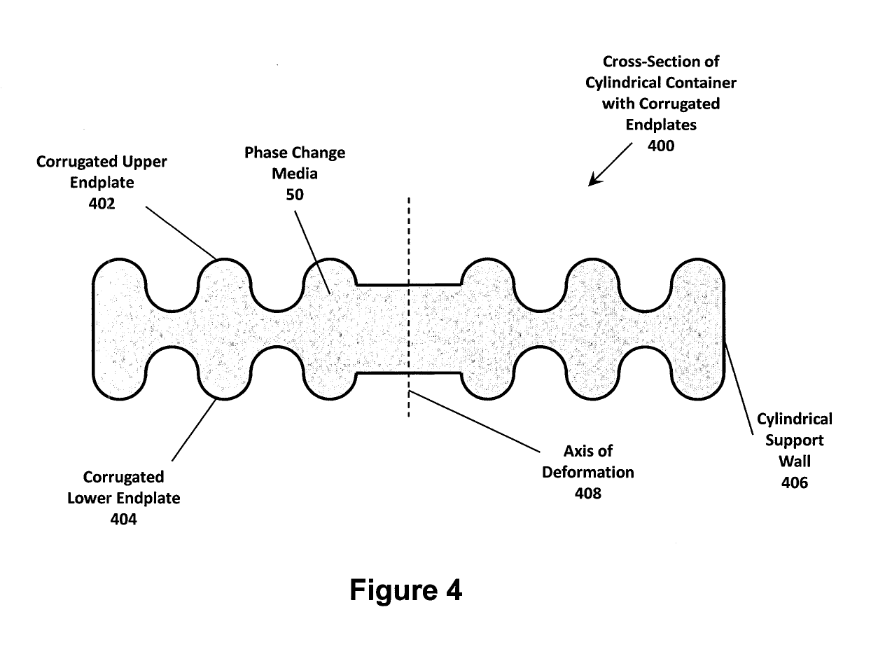

FIG. 4 is a lateral cross-section of a container such as that which was disclosed as container 300 in FIG. 3 for a thermal expansion module for a high-temperature thermal actuator. The corrugated upper endplate 402 has concentric corrugations that are mirrored on the corrugated lower endplate 404. The volume of phase change media 50 may be varied to achieve the desired displacement of the centers of plates 402 and 404 towards or away from each other primarily via the height of cylindrical support wall 406. Translation of this particular displacement would be acting along the axis of deformation 408.

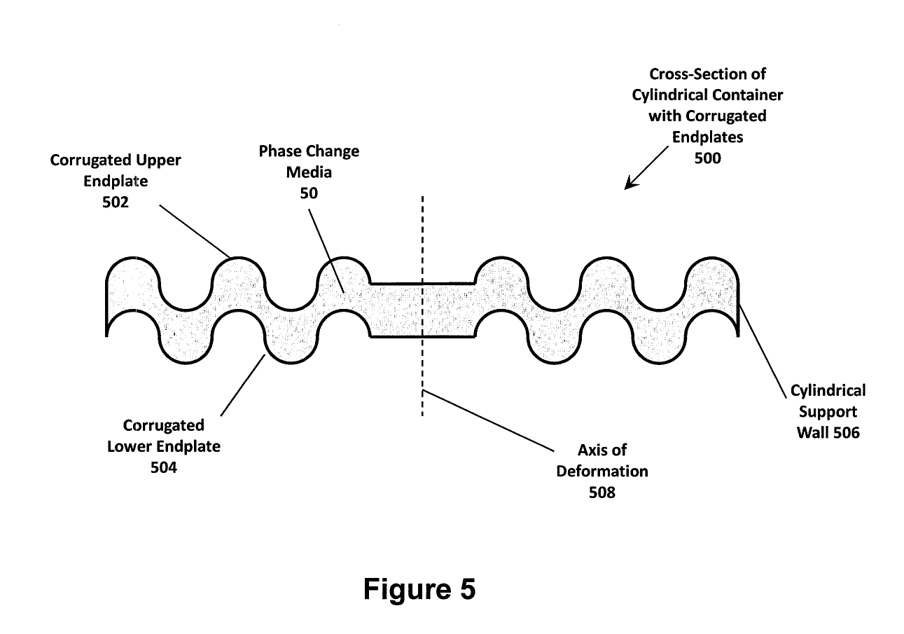

FIG. 5 illustrates yet another embodiment of a container such as that which was disclosed as container 300 in FIG. 3. In this case, the concentric corrugations of upper endplate 502 and lower endplate 504 are offset to “nest” into one another. This geometry allows for a smaller contained volume if desired. In addition, there is now a smaller distance from the surface of container 500 to any location within the phase change media 50, as compared to the geometry of corrugated endplates 402 and 404 in FIG. 4 for the same separation of the flat surfaces along the axes of deformation 408 and 508. This tighter spacing would facilitate heat transfer into and out of the phase change media 50.

Inorganic salt combinations, as well as additional mentioned phase change material (PCM) examples, may provide PCM's that exhibit the property that their volume increases with the transition from solid to liquid phase. Unary (single component) PCM's make the volume change at a fixed temperature, but PCM mixtures and alloys may change volume over a broader temperature range. The volume change realized upon melting provides application as a thermostatic actuator at temperatures and/or forces that are impossible for wax pellet and passive bimetallic element thermostats. Specifically tailored PCM mixtures make it possible to design a range of thermostats that will open progressively over temperature ranges that may be tailored within certain constraints. Specific materials and mixtures may be used to achieve desired application-specific temperature activation ranges, these may include but are not limited to: inorganic salts; metals; non-metals; mixtures of metals and non-metals; or any combination thereof.

Total deflection experienced by the actuator is constrained by the need to keep stresses within acceptable limits, and compatibility between the PCM and the enclosure material is a consideration due to corrosion issues. In addition to a tailored temperature range, melting PCM's may exert enormous pressures due to the incompressibility of liquid, thereby mitigating issues regarding the actuation force required to displace an actuator.

If a PCM solidifies with voids when pressure inside the container is lower than the external pressure, a spring-loaded mechanism may be applied to avoid the formation of vacuum voids. Thus, the phase change media chamber is consistently constrained to a minimum volume.

The advantages of PCM's, and in particular inorganic salts, metals and nonmetals for use in the embodiments of the disclosed thermostatic actuator include; the ability to tailor the temperature range over which the thermostat opens/closes; negligible thermal growth from room temperature to actuation temperature relative to actuation displacement; displacement can be tailored by the combination of the fractional volume change of the PCM and the enclosed volume of PCM; forces generated during the phase change process are more than sufficient to move most spring return valves; the system operates in very diverse space requirements, temperature ranges and actuator displacements; and, mechanical amplification may be employed to achieve a broad range of actuation displacements.

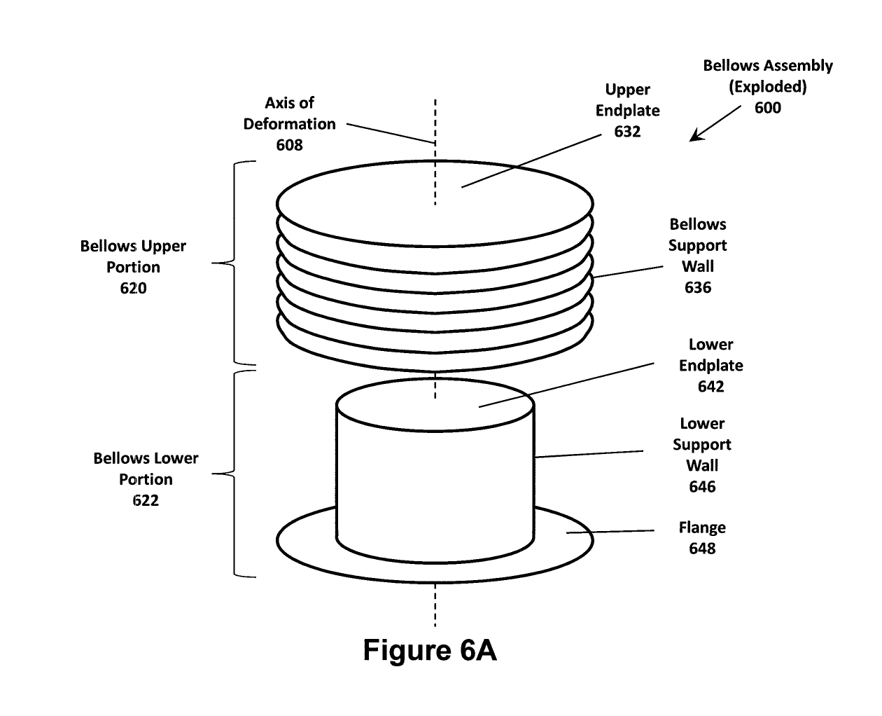

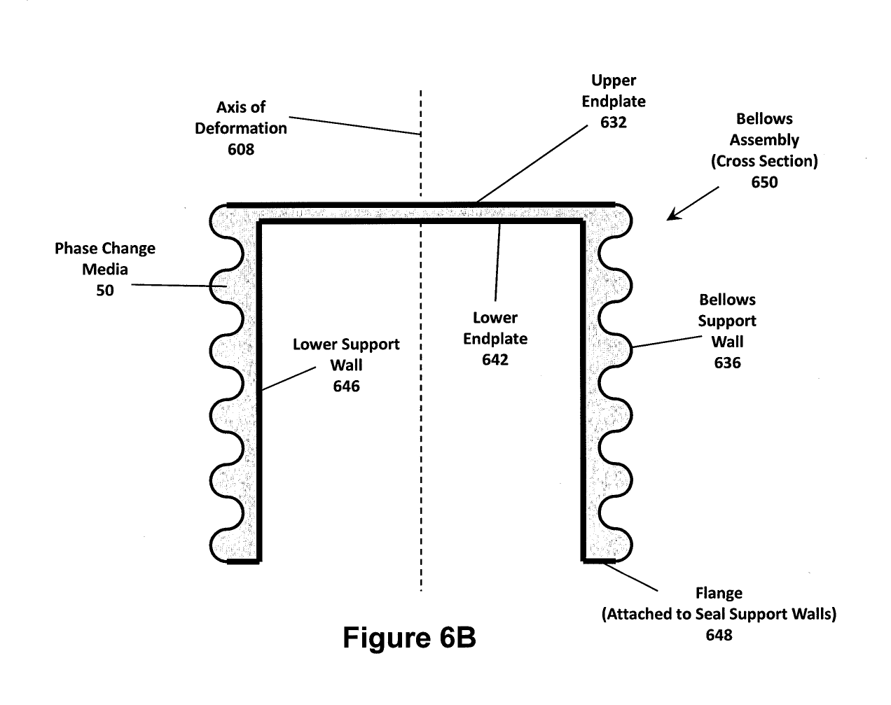

FIG. 6A is an exemplary embodiment of an exploded view of a bellows assembly 600 utilizing a combination of bellows and a cylindrical container for a high-temperature thermal actuator. The bellows upper endplate 632 is attached to bellows support wall 636, making bellows upper portion 620. The bellows lower support wall 646 is attached to flange 648 in the lower portion and is capped with lower endplate 642 at the upper end, giving a geometry that looks like a formal top hat, comprising the bellows lower portion 622. The bellows upper and lower portions 620 and 622 are hermetically sealed with phase change material (not shown) filling the enclosed cavity between them. The diameter of lower support wall 646 will be sized to ensure appropriate guidance of bellows of the bellows support wall 636 as it lengthens and shortens, preventing undesirable buckling of the bellows.

FIG. 6B is a cross sectional, side-view of an embodiment of a thermal expansion module 650 for the high-temperature thermal actuator of bellows assembly 600 shown in FIG. 6A. As detailed in FIG. 6B, a phase change media 50 is disposed within the sealed confines of a thermal expansion module 650 and acts to exert dimensional force in at least one direction along axis of deformation 608 in response to a temperature change that causes the media to undergo dimensional change due to a change in phase. The shape and height of lower support wall 646 relative to bellows support wall 636 is designed to accommodate the required volume change of phase change media 50 with the desired displacement of upper endplate 632 and the upper surface of the lower endplate 642, thereby ensuring that stresses in the corrugations of bellows support wall 636 are within acceptable limits. The diameter of lower support wall 646 is sized to ensure appropriate guidance of bellows support wall 636 as it lengthens and shortens, preventing undesirable buckling of the bellows.

Upper endplate 632 and lower endplate 642 at the top of lower support wall 608 are the surfaces that will transfer longitudinal displacement of bellows assembly 650 to an external mechanism benefitting from the displacement within the sealed confine which is in the shape of a capped hollow cylinder.

Volume change of the phase change material 50 will result in a change in the height of upper endplate 632, and a change in the distance between the surfaces of the lower endplate 642 and upper endplate 632. The volume of phase change material between the surfaces of the lower endplate 642 and upper endplate 632 facilitates that the height change of the bellows support wall 636 will be less than the fraction volume change of phase change material 50 when changing state from solid to liquid or vice versa as phase change media may move from the annular cavity between walls 636 and 646 into the diskshaped cavity between endplates 632 and 642 or vice versa.

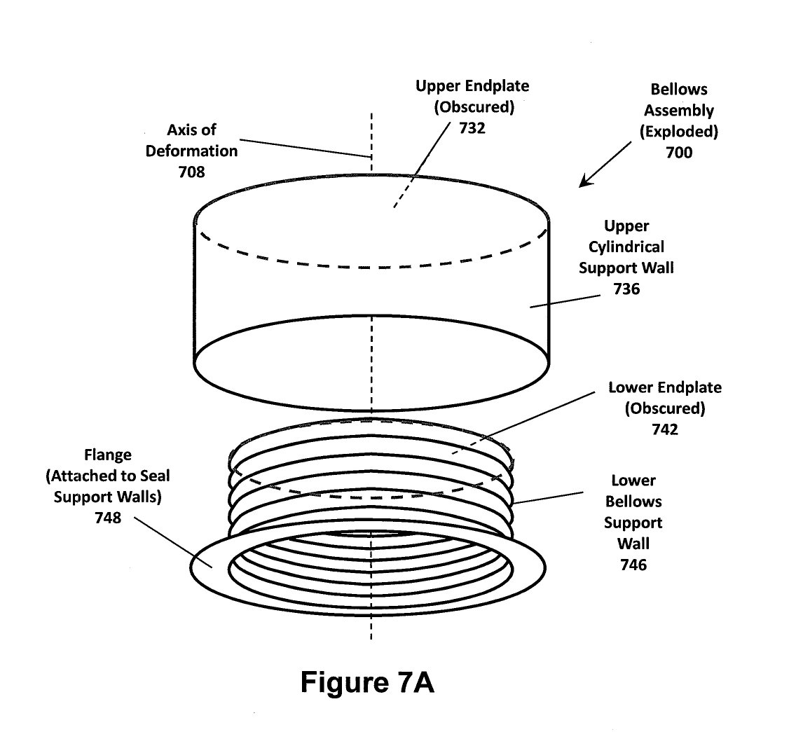

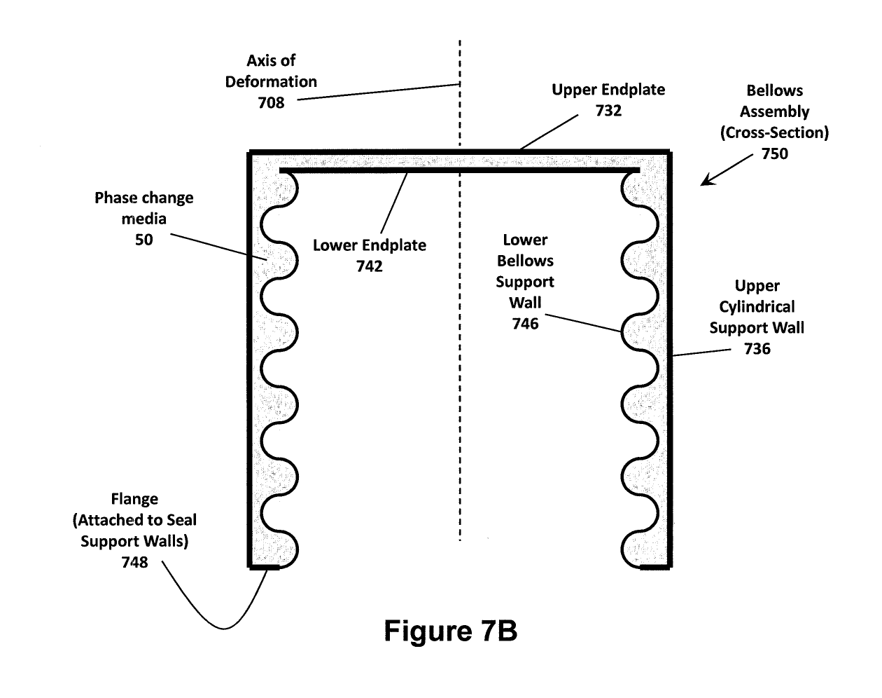

FIG. 7A is another exemplary embodiment of an exploded view of a bellows assembly 700 utilizing a combination of internal bellows and an external cylindrical container for a high-temperature thermal actuator. The lower bellows support wall 746 is attached to flange 748 and an upper endplate 732 (obscured and shown in phantom lines) and these fit within upper cylindrical support wall 736. The upper cylindrical support wall 736 and lower bellows support wall 746 are hermetically sealed with the flange 748 and filled with phase change material (not shown) filling the enclosed cavity. The diameter of the upper cylindrical support wall 736 will be sized to ensure appropriate guidance of the lower bellows support wall 746 as it lengthens and shortens, preventing undesirable buckling of the bellows.

FIG. 7B is a cross sectional side-view of an embodiment of the thermal expansion module for a high-temperature thermal actuator bellows assembly 750 that was shown in FIG. 7A. As detailed in FIG. 7B, a phase change media 50 is disposed within the sealed confines of a thermal expansion module and acts to exert dimensional force in at least one direction along axis of deformation 708 in response to a temperature change that causes the media to undergo dimensional change due to a change in phase. The shape and height of upper cylindrical support wall 736 relative to lower bellows support wall 746 is designed to accommodate the required volume change of phase change media 50 with the desired displacement of upper endplate 732 and the lower endplate 742 capping lower bellows support wall 746, thereby ensuring that stresses in the corrugations of lower bellows support wall 746 are within acceptable limits. The diameter of the upper cylindrical support wall 736 is sized to ensure appropriate guidance of lower bellows support wall 746 as it lengthens and shortens, preventing undesirable buckling of bellows.

Volume change of the phase change material 50 within the sealed confine, which is in the shape of a capped hollow cylinder, will result in a change in the height of lower bellows support wall 746, and a change in the distance between the surfaces of the upper endplate 732 and the lower endplate 742. The volume of phase change material between the surfaces of the upper endplate 732 and the lower endplate 742 at the upper cylindrical support wall 736 facilitates that the height change of the upper cylindrical support wall 736 will be less than fraction volume change of phase change material 50 when changing state from solid to liquid or vice versa, as phase change media may move from the annular cavity between walls 736 and 746 into the disk-shaped cavity between endplates 732 and 742 or vice versa.

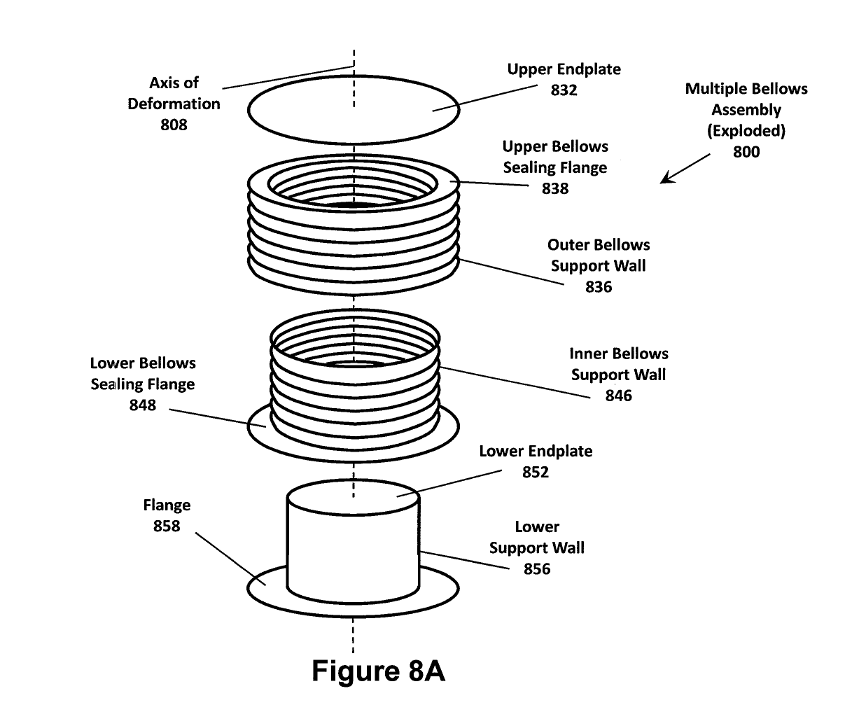

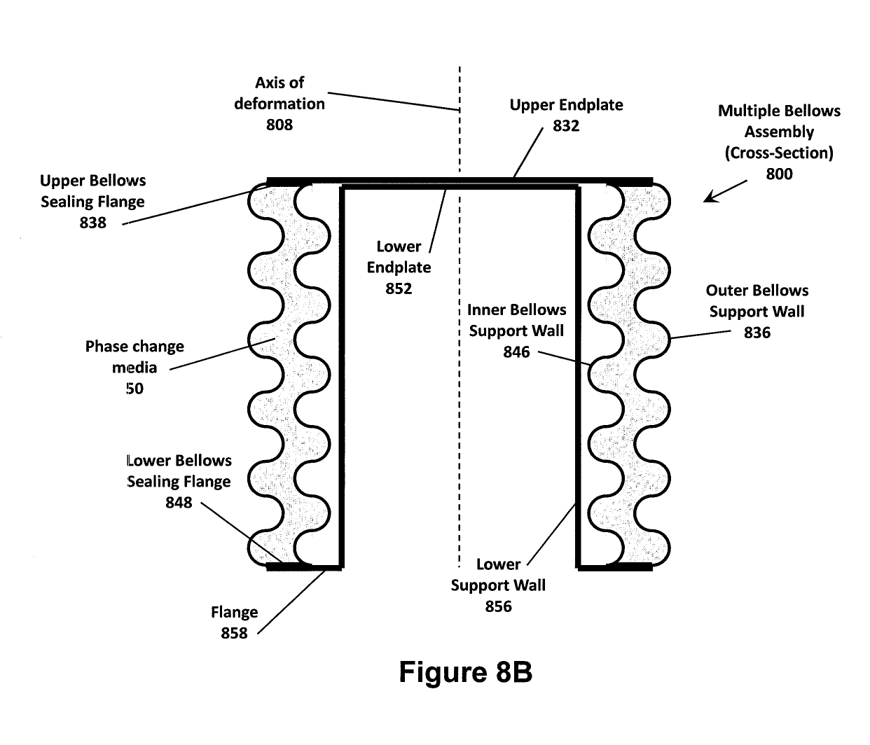

FIG. 8A is an exemplary embodiment of an exploded view of a multiple bellows assembly 800 utilizing a combination of internal and external concentric bellows for a high-temperature thermal actuator. In this embodiment, inner bellows support wall 846 and outer bellows support wall 836 are sealed on one end with an upper bellows sealing flange 838 and with a lower bellows sealing flange 848 on the opposing end. Displacement from the upper flange 838 and lower flange 848 is transferred via upper endplate 832 and lower endplate 852 or flange 858. Upper endplate 832 and the flange 858 must be in contact with upper bellows sealing flange 838 and lower bellows sealing flange 848 respectively such that a change of volume within the flanged space exerts a longitudinal force on the sealing flanges 838 and 848. The diameter of the cylindrical portion of the lower support wall 856 is sized to fit closely inside the inner bellows support wall 846 to provide appropriate guidance of the bellows assembly as it lengthens and shortens, preventing undesirable buckling of the multiple bellows assembly 800.

FIG. 8B is a cross sectional side-view of the embodiment of the multiple bellows assembly 850 shown in FIG. 8A. In this embodiment, a phase change media 50 is disposed within the sealed confines of a thermal expansion module and acts to exert dimensional force in at least one direction along axis of deformation 808 in response to a temperature change that causes the media to undergo dimensional change due to a change in phase. The volume of phase change media 50 contained between outer bellows support wall 836 and inner bellows support wall 846, and between the upper bellows sealing flange 838 and the lower bellows sealing flange 848 is designed to deliver the desired height change of the bellows assembly 850, ensuring that stresses in the corrugations of outer bellows support wall 836 and inner bellows support wall 846 are within acceptable limits. The diameter of lower support wall 856 is sized to ensure appropriate guidance of inner bellows support wall 846 (and by extension outer bellows support wall 836) as it lengthens and shortens, thereby preventing undesirable buckling of these bellows 836 and 846. The separation between the top of lower endplate 852 and upper endplate 832 may be varied continuously from almost touching to any distance desired. Such separation choice allows for a wide range of packaging options for a thermostatic actuator.

The change in volume fraction of the phase change material 50, which is in the shape of a hollow cylinder, will result in the same fraction change in the length of the walls of outer bellows support wall 836 and the inner bellows support wall 846, and by extension, the same change in the distance between the surfaces of the upper endplate 832 and the lower endplate 852 or the flange 858.

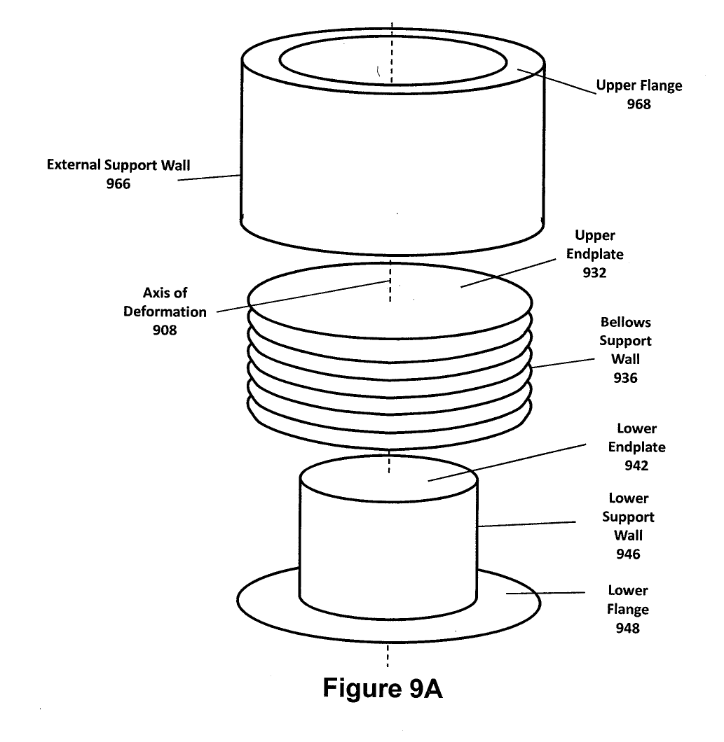

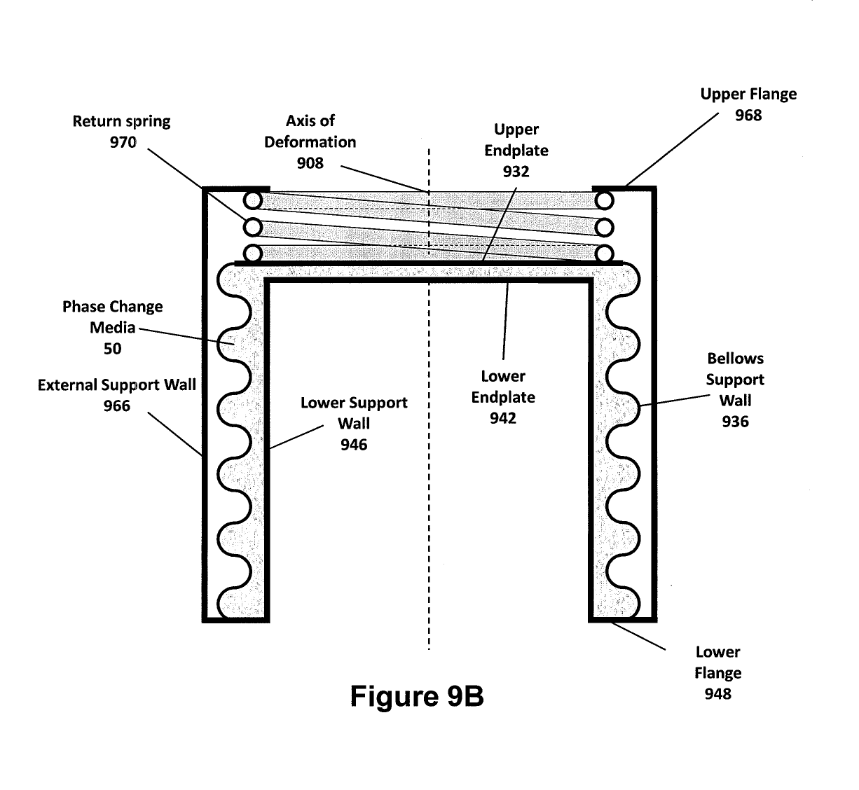

In the case of the bellows configuration, it is also contemplated that the “top hat” geometry be designed to reduce displacement upon volume increase of the phase change material, as demonstrated in FIG. 9A. This geometry is similar to the embodiment of FIG. 6A, with the exception that the lower flange 948 is wider than the flange 648, and it mates to an external support wall 966. The upper flange 968 is also connected to the external support wall 966. The combination of the upper support wall 966 and the upper flange 968 look like an open cylinder with an annular cap on top.

FIG. 9B is a cross-sectional, side view of the geometry shown in FIG. 9A, with the components in their assembled positions. A lower flange 948 joins a lower support wall 946, a bellows support wall 936 and an external support wall 966. Upon increase in volume of phase change media 50, the distance between the lower flange 948 (and lower endplate 942) and the upper endplate 932 will increase, but at the same time the distance between the upper endplate 932 and the upper flange 968 will decrease. A return spring 970 (not shown in FIG. 9A) may be used to ensure that the distance between the upper endplate 932 and the upper flange 968 will decrease as phase change media 50 reduces its volume.

An increase in distance between the upper endplate 932 and the lower endplate 942 (or lower flange 948) will allow an actuation motion that pushes on the actuator. An increase in distance between the upper endplate 932 and the upper flange 968 will allow an actuation motion that pulls on the actuator.

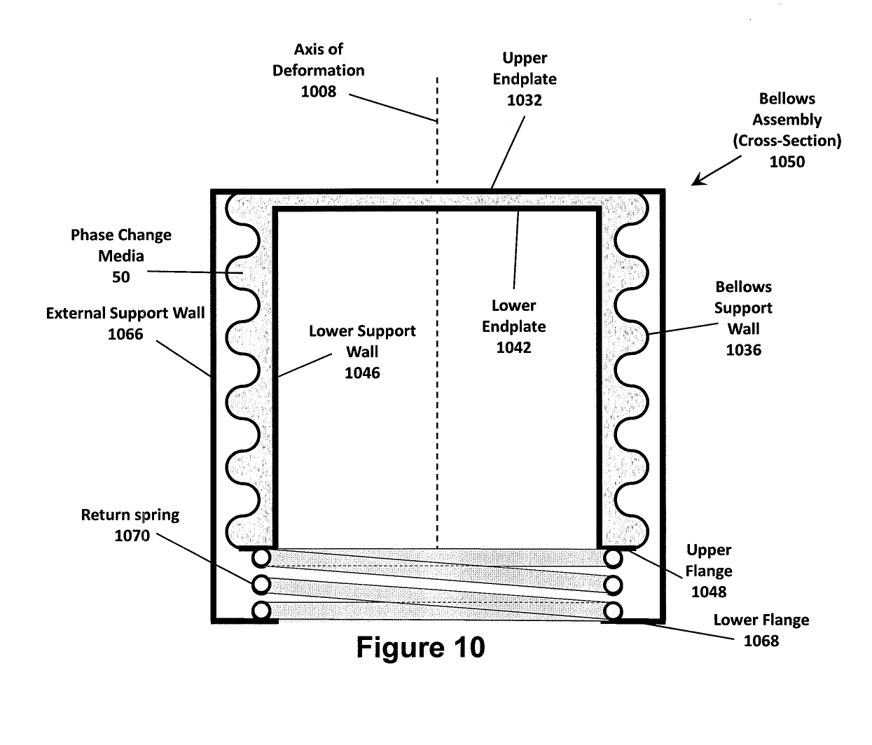

FIG. 10 is a cross-sectional, side view similar to the geometry shown in FIG. 9B, but with the external support wall 1066 attached to an upper endplate 1032 and to the lower flange 1068. In this case, the lower flange 1068 will move towards both the lower endplate 1042 and the upper flange 1048 upon an increase in volume of phase change media 50. This configuration allows the bellows assembly 1050 to be packaged in such a way that the connections points to an actuator (not shown), may fit within the envelope defined by a lower endplate 1042, a lower support wall 1046, a return spring 1070 and a lower flange 1068.

Because of the aforementioned advantages, the disclosed embodiments lend to a wide variety of applications. For example, the volume of the phase change media can be tailored to produce a range of deflections (within the stress constraints) with the same outer shell, and the temperature range can be tailored by the selection of the phase change media. In this manner, bellows-style actuators for different temperatures and displacements can be made from relatively common components. Thus, a platform approach, with different diameters and/or lengths for different deflections and package constraints can be readily utilized. The aforementioned embodiments additionally allow for a high-temperature thermal actuator with the ability to control where deflection occurs on the surface of a shape, as well as in applications where the actuator deflection must be in a specific direction. Utilizing these embodiments, the location of the deflection can easily be controlled to manage stresses, which are easily held below any applicable limits, such as yield.

The foregoing description of the invention has been presented for purposes of illustration and description. It is not intended to be exhaustive or to limit the invention to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments of the invention except insofar as limited by the prior art.

The embodiments of the invention in which an exclusive property or privilege is claimed are defined as follows:

1. A thermal actuator comprising:
a sealed volumetric confine comprising:
an upper endplate orthogonal to an axial orientation;
a lower endplate orthogonal to an axial orientation, approximately parallel to, and offset by, a distance from said upper endplate;
at least one flexible support wall that is disposed in a circumferential orientation to engage said upper endplate and said lower endplate, thereby forming said sealed confine; and,
a phase change media disposed within said confine, said phase change media that responds to a temperature change to exert dimensional force in said axial orientation upon a change of state, thereby changing the distance between said upper endplate and said lower endplate.

2. The thermal actuator of claim 1 further comprising:
a second support wall that is disposed in a circumferential orientation to engage said upper endplate and said lower endplate, thereby forming said sealed confine in the shape of a hollow cylinder.

3. The thermal actuator of claim 1 further comprising:
a second support wall that is disposed in a circumferential orientation to engage said upper endplate and said lower endplate, thereby forming said sealed confine in the shape of a capped hollow cylinder.

4. The thermal actuator of claim 1 wherein said sealed volumetric confine is a hollow cylinder.

5. The thermal actuator of claim 1 wherein said sealed volumetric confine is a capped hollow cylinder.

6. The thermal actuator of claim 2 wherein said flexible support wall is located outside of said second support wall.

7. The thermal actuator of claim 1 wherein said flexible support wall is located inside of said second support wall.

8. The thermal actuator of claim 1 wherein said second support wall is flexible.

9. The thermal actuator of claim 1 wherein said phase change media comprises one or more inorganic salts.

10. The thermal actuator of claim 1 wherein said phase change media comprises one or more metals.

11. The thermal actuator of claim 1 wherein said phase change media comprises one or more non-metals.

12. The thermal actuator of claim 1 wherein said phase change media comprises any combination of one or more inorganic salts, one or more metals, and one or more non-metals.

13. The thermal actuator of claim 1 wherein said sealed volumetric confine is a cylinder.

14. The actuator of claim 1 wherein said sealed volumetric confine contains a combination of said phase change media and an inert filler media.

15. The actuator of claim 1 wherein said flexible support wall further comprises a plurality of flexible corrugated elements forming a bellows.

16. The actuator of claim 1 further comprising:
a valve assembly in communication with said sealed volumetric confine that opens and closes in response to variations in said distance of said upper endplate and said lower endplate thereby regulating the flow of a fluid.

17. The actuator of claim 1 further comprising:
an upper flange orthogonal to said axial orientation;
a lower flange orthogonal to said axial orientation, approximately parallel to, and offset by, a distance from said upper flange, said upper flange disposed to rigidly connect to said lower endplate via said lower flange, and whereby changing the distance between said upper endplate and said lower endplate will conversely change the distance between said upper endplate and said upper flange.

18. The actuator of claim 1 further comprising:
an upper flange orthogonal to said axial orientation;
a lower flange orthogonal to said axial orientation, approximately parallel to, and offset by, a distance from said upper flange, said upper flange disposed to rigidly connect to said lower endplate, said lower flange disposed to rigidly connect to said upper endplate, and whereby changing the distance between said upper endplate and said lower endplate will conversely change the distance between said lower endplate and said lower flange.

19. A method of affecting mechanical displacement with a thermal actuator comprising:
providing a sealed volumetric confine comprising:
an upper endplate orthogonal to an axial orientation;
a lower endplate orthogonal to an axial orientation, approximately parallel to, and offset by, a distance from said upper endplate;
at least one flexible support wall that is disposed in a circumferential orientation to engage said upper endplate and said lower endplate, thereby forming said sealed confine;
providing a phase change media within said volume of said confine;
heating or cooling said phase change media beyond a phase transition point thereby affecting a change in state of said phase change media by changing the temperature of said phase change media disposed within said confine thereby affecting a change in volume of said confine; and,
creating a change in displacement between said upper endplate and said lower endplate with the force exerted by said phase change media upon said change of state.

20. The method of claim 19 further comprising the step:
providing said phase change media comprising one or more inorganic salts.

21. The method of claim 19 further comprising the step:
providing said phase change media comprising one or more metals.

22. The method of claim 19 further comprising the step:
providing said phase change media comprising one or more non-metals.

23. The method of claim 19 further comprising the step:
providing said phase change media comprising any combination of one or more inorganic salts, one or more metals, and one or more non-metals.

24. The method of claim 19 further comprising the step:
providing said sealed volumetric confine in the shape of a cylinder.

25. The method of claim 19 further comprising the step:
providing said sealed volumetric confine in the shape of a hollow cylinder.

26. The method of claim 19 further comprising the step:
providing an inert filler media with said phase change media within said volume of said confine.

27. The method of claim 19 further comprising the step:
regulating the flow of a fluid by opening or closing a valve assembly that is in communication with said sealed volumetric confine; and,
opening and closing said valve assembly in response to variations in said distance of said upper endplate to said lower endplate.

28. The method of claim 19 further comprising the step:
creating a converse change in displacement between said upper endplate and an upper flange that is rigidly connected to said lower endplate via a lower flange disposed between said lower endplate and said upper flange.

29. The method of claim 19 further comprising the step:
creating a converse change in displacement between said lower endplate and a lower flange that is rigidly connected to said upper endplate.
